(19) United States
(12) Patent Application Publication
(10) Pub. No.: US 2015/0355351 A1
(43) Pub. Date: Dec. 10, 2015

(54) System and Method for Generating and Controlling Conducted Acoustic Waves for Geophysical Exploration

(71) Applicant: Soundblast Technologies, LLC, Winter Park, FL (US)

(72) Inventors: Larry W. Fullerton, New Hope, AL (US); Mark D. Roberts, Huntsville, AL (US); James L. Teel, Winter Park, FL (US); Herman M. Thompson, Keslo, TN (US); William Davie, Banchory (GB)

(73) Assignee: SOUNDBLAST TECHNOLOGIES, LLC, Winter Park, FL (US)

(21) Appl. No.: 14/811,614

(22) Filed: Jul. 28, 2015

Related U.S. Application Data
(63) Continuation-in-part of application No. 14/699,742, filed on Apr. 29, 2015.
Application No. 14/699,742 is a continuation-in-part of application No. 14/176,068, filed on Feb. 8, 2014, now Pat. No. 9,116,252.
Application No. 14/176,068 is a continuation-in-part of application No. 13/669,985, filed on Nov. 6, 2012, now Pat. No. 8,905,186.
Application No. 13/669,985 is a continuation-in-part of application No. 13/049,386, filed on Mar. 16, 2011, now Pat. No. 8,302,730.
Application No. 13/049,386 is a continuation of application No. 11/785,327, filed on Apr. 17, 2007, now Pat. No. 8,292,022.
(60) Provisional application No. 62/029,872, filed on Jul. 28, 2014.
(60) Provisional application No. 60/792,420, filed on Apr. 17, 2006.
(60) Provisional application No. 60/850,685, filed on Oct. 10, 2006.

(51) Int. Cl. G01V 1/02

(52) U.S. Cl. CPC G01V 1/02; G01V 2210/32

(57) ABSTRACT

An improved seismic impulse acquisition system involves an array of seismic sources comprising direct detonation overpressure wave generators that are geographically scattered, an array of echo detectors configured to detect said seismic impulses imparted by each seismic source of said array of seismic sources, a data recorder, said array of echo detectors being connected to said data recorder, a control system, and a network that connect the array of seismic sources and the array of echo detectors to said control system. Each seismic source imparts seismic impulses into a target media in accordance with a respective code sequence of a plurality of code sequences, wherein the location of each seismic source and each echo detector at a given time is known relative to an established coordinate system. The various coded sequences of seismic pulses are used to process the data received by the data recorder from the array of echo detectors.

### CROSS REFERENCE TO RELATED PATENTS AND PATENT APPLICATIONS

This U.S. Provisional application is a continuation-in-part Application of U.S. Non-Provisional application Ser. No. 14/699,742, filed Apr. 29, 2015, titled “System and Method for Harnessing Pressure Produced by a Detonation” and claims priority to U.S. Provisional Patent Application 62/029,872 filed Jul. 28, 2014; Ser. No. 14/699,742 is a continuation-in-part Application of U.S. Non-Provisional application Ser. No. 14/176,068, filed Feb. 8, 2014, titled “System and Method for Coupling an Overpressure Wave to a Target Media”, which is a Continuation-in-Part Application of pending U.S. Non-Provisional application Ser. No. 13/669,985, filed Nov. 6, 2012, titled “System and Method for Coupling an Overpressure Wave to a Target Media”, which is a Continuation-in-Part of U.S. Pat. No. 8,302,730, issued Nov. 11, 2012, which is a Continuation-in-Part of U.S. Pat. No. 8,292,022, issued Oct. 23, 2012, which claims priority to U.S. Provisional Patent Application 60/792,420, filed Apr. 17, 2006, and U.S. Provisional Patent Application 60/850,685, filed Oct. 10, 2006. These related patents and patent applications are all incorporated herein by reference in their entirety.

### FIELD OF THE INVENTION

The present invention relates generally to a system and method for generating and controlling an overpressure wave. More particularly, the present invention relates to controlling the detonation of a fuel-oxidant mixture flowing within a tubular structure to generate an overpressure wave used to produce a conducted acoustic wave that can be used to explore or otherwise characterize a region of interest within a target media. More particularly, the present invention also relates to controlling the detonation of a fuel-oxidant mixture flowing within one or more tubular structures to generate and control conducted acoustic waves for geophysical exploration purposes.

### SUMMARY OF THE INVENTION

In one aspect, the invention includes a seismic impulse acquisition system, comprising an array of seismic sources comprising direct detonation overpressure wave generators, each of the seismic sources of the array of seismic sources being geographically scattered, wherein each seismic source of the array of seismic sources imparts seismic impulses into a target media in accordance with a respective code sequence of a plurality of code sequences, an array of echo detectors configured to detect the seismic impulses imparted by each seismic source of the array of seismic sources, a data recorder, the array of echo detectors being connected to the data recorder, a control system, a network, the network connecting the array of seismic sources and the array of echo detectors to the control system; wherein the location of each seismic source of the array of seismic sources and each echo detector of the array of echo detector at a given time is known relative to an established coordinate system; wherein the various coded sequences of seismic pulses are used to process the data received by the data recorder from the array of echo detectors; wherein multiple seismic sources of the plurality of seismic source can be firing simultaneously.

Each code sequence of the plurality of code sequences can correspond to a channel.

The respective code sequences used by a given seismic source and correlation methods can be used to determine information resulting from the firing of a given seismic source.

The network can include at least one of wired connectivity or wireless connectivity.

The established coordinate system can be a global positioning system coordinate system.

The location of a given seismic source of the array of seismic sources or a location of a given echo detector of the array of echo detectors can be fixed or vary depending on whether the given seismic source or the given echo detector is fixed or mobile.

A code sequence of the plurality of code sequences can be substantially orthogonal to any other code sequence of the plurality of code sequences.

A code sequence may correspond to a Galois sequence.

A code sequence may correspond to one of a Hadamard code, Gold code, Walsh code,

Kasami sequence, Chu sequence, hyperbolic congruential code, quadratic congruential code, linear congruential code, chaotic code, Golomb Ruler code, or pseudo-random code.

A code sequence can define at least one of seismic impulse amplitude, seismic impulse frequency, or seismic impulse width.

Chirped seismic impulses and chirp processing methods can be employed.

Each seismic source and each echo detector can be in wired or wireless communication with a common time reference.

A common time reference may be provided by a time server which may be connected to one of a radio clock, an atomic clock, or a GPS master clock.

A coded sequences of seismic impulses can be repeated over time enabling coherent integration methods to be employed so as to increase signal-to-noise ratios.

Seismic impulses can be produced in accordance with one of Division Multiple Access

(TDMA) channel access method, a Code Division Multiple Access (CDMA) method, or a Frequency Division Multiple Access (FDMA) method.

The firing of a coded sequence of impulses by a seismic source can be controlled based on one or more noise measurements, where a given seismic source has a schedule of time windows in which it is authorized to fire, where for a given window within the schedule of time windows, the seismic source may or may not fire due to measured noise and an established noise threshold, where whenever a seismic source fires it reports or records the timing of its firing to be used for processing.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A and 1B depict an exemplary overpressure wave generator;

FIG. 2 depicts an exemplary seismic exploration system;

FIG. 3 depicts an exemplary coupling component that includes a coupling chamber a cylinder, a piston, and an earth plate;

FIG. 4 depicts an exemplary coupling component that includes a coupling chamber and a push plate;

FIG. 5A depicts an exemplary coupling component that includes a coupling chamber, a flexible membrane, and a push plate assembly comprising a top plate, a piston rod, a movement constraining vessel, and an earth plate;

FIG. 5B depicts an exemplary coupling component that includes a coupling chamber, a movement constraining vessel, a stabilizing component, a push plate assembly comprising a top plate, a piston rod, and an earth plate, and a stop component;

FIG. 5C depicts the exemplary coupling component of FIG. 5B prior to detonation;

FIG. 5D depicts the exemplary coupling component of FIG. 5B immediately after detonation;

FIG. 5E depicts an exemplary stabilizing component; and

FIG. 6 depicts an exemplary simultaneous seismic impulse acquisition system.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising overpressure wave generators, methods for using overpressure wave generators, and so forth. Example realizations for such embodiments may be facilitated, at least in part, by the use of an emerging, revolutionary overpressure wave generation technology that may be termed direct detonation overpressure wave generation that enables precision timing and amplitude control of detonations and corresponding generated overpressure waves. Alternatively, the technology may be termed instantaneous detonation or any other such terminology indicative that detonation is achieved without deflagration, or in other words, without a deflagration to detonation transition (DDT) process.

Direct detonation technology was first fully described and enabled in the co-assigned U.S. Pat. No. 7,883,926 issued on Feb. 8, 2011 and entitled “System and Method for Generating and Directing Very Loud Sounds”, the co-assigned U.S. Pat. No. 7,886,866 issued on Feb. 15, 2011 and entitled “System and Method for Ignition of a Gaseous or Dispersed Fuel-oxidant Mixture”, and the co-assigned U.S. Pat. No. 8,292,022, issued on Oct. 23, 2012 and entitled “System and Method for Generating and Controlling Conducted Acoustic Wave for Geophysical Exploration”. The contents of these documents are hereby incorporated herein by reference. A second generation of a direct detonation overpressure wave technology is described and enabled in the co-assigned U.S. Pat. No. 8,302,730, issued on Nov. 6, 2012, and entitled “System and Method for Generating and Controlling Conducted Acoustic Wave for Geophysical Exploration”. The contents of this document are hereby incorporated herein by reference.

The present invention pertains to a system and method for

### Direct Detonation Overpressure Wave Generator Background

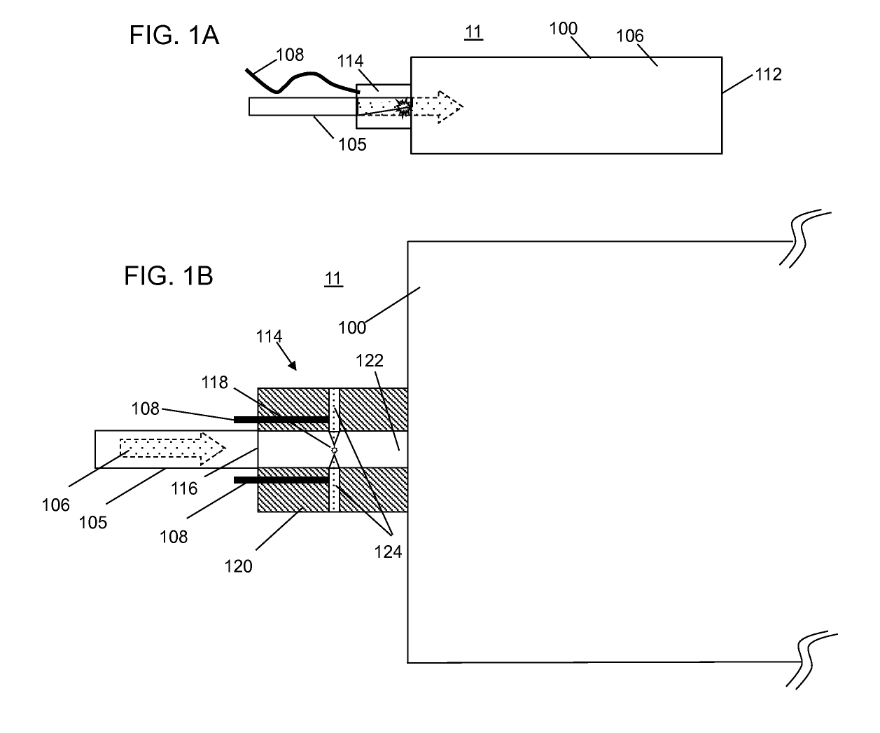

FIGS. 1A and 1B depict an exemplary direct detonation overpressure wave generator. FIG. 1A depicts a detonation tube 100 of an overpressure wave generator 11 being supplied by fuel-oxidant mixture supply 105 via a detonator 114, where a spark ignites within the fuel-oxidant mixture 106 while the detonation tube 100 is being filed with the fuel-oxidant mixture 106 instantly causing detonation at the point of ignition that causes a detonation wave to propagate down the length of the detonation tube 100 and exit its open end 112.

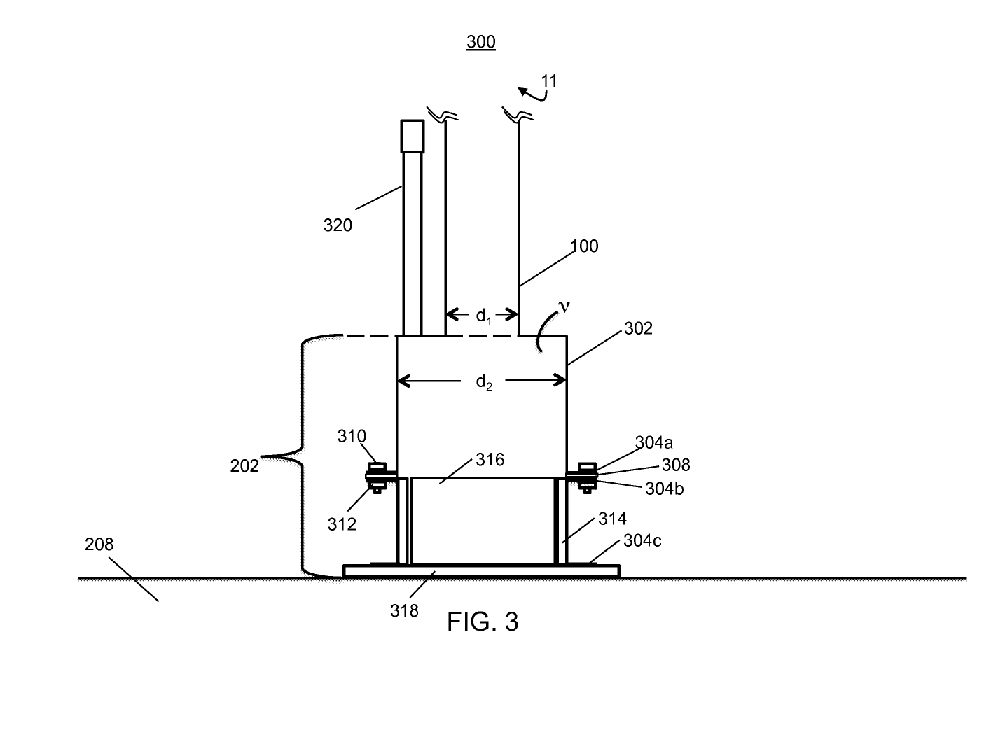

As shown in 1B, the detonator 114 comprises an electrically insulating cylinder 120 surrounding a detonator tube 122. Electrodes 124 are inserted from the sides of insulating cylinder 120 and are connected to high voltage wire 108. The detonator tube 122 is connected to fuel-oxidant mixture supply 105 (shown in FIG. 3B) at a fill point 116 and to a detonation tube 100 at its opposite end. As shown in FIG. 1B, a gas mixture 106 is passed into the detonator tube 122 and then into the detonation tube 100 via a fill point 116 of the detonator 114. When the detonation tube 100 is essentially full, high voltage wire 108 is triggered to cause a spark 118 to occur across electrodes 124 and to pass through the gas mixture 106 flowing into detonator tube 122 to initiate detonation of the gas in the detonation tube 100.

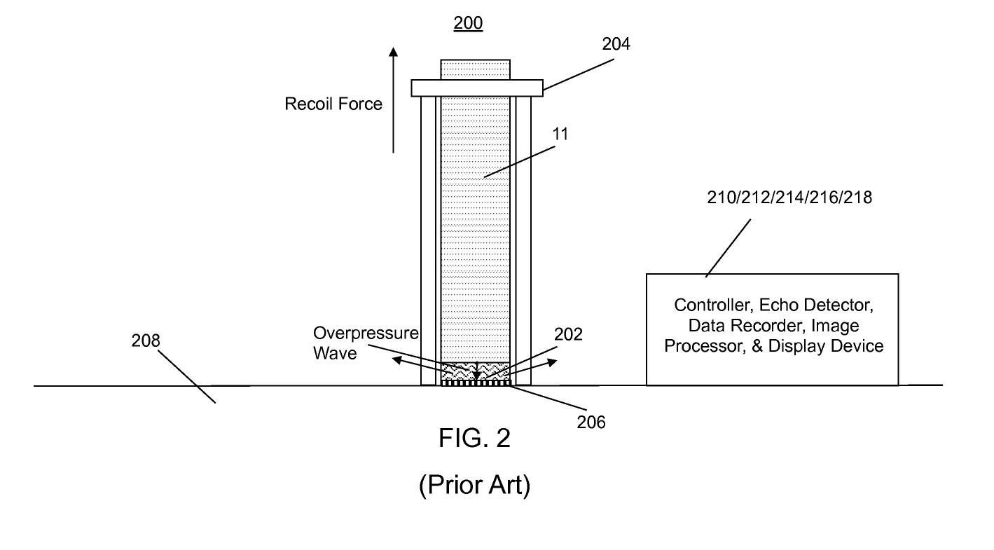

FIG. 2 depicts an exemplary seismic exploration system 200 that includes an overpressure wave generator 11, a coupling component 202, a stabilizing mechanism 204 for controlling the movement of the overpressure wave generator, a controller 210 for controlling the operation of the overpressure wave generator 11, an echo detector 212, a data recorder 214, an image processor 216, and a display device 218. The open end of the overpressure wave generator 11 is configured such that generated overpressure waves are directed towards a target media 208. It should be understood that while the foregoing elements of the system 200 are identified separately, these elements do not necessarily have to be physically separated and can be configured in various alternative ways.

The exemplary overpressure wave generator 11 of system 200 includes a source for producing a spark, a detonation tube, a gas mixture source that provides the flowing gas into the detonation tube, and a detonator. The overpressure wave generator can alternatively comprise a group of detonation tubes that are detonated simultaneously so as to produce a combined overpressure wave. The system 200 can be implemented using one or more nozzles so as to more closely match the impedance of the detonation wave generated by the overpressure wave generator to the impedance of the ambient environment, e.g., the air, thereby reducing the reflection of energy back into the overpressure wave generator, increasing the strength of the overpressure wave that is generated, increasing the resulting force produced by the overpressure wave, and resulting in stronger conducted acoustic waves.

The overpressure wave generator is detonated to generate an overpressure wave. The force of the generated overpressure is coupled by coupling component 202 to a target media 208 such as the ground, ice, or water to produce a conducted acoustic wave. Stabilizing mechanism 204 provides stability to the movement of the overpressure wave generator 11 essentially allowing only up and down movement or substantially preventing movement altogether.

Coupling component 202 may comprise air, a liquid, a spring or may comprise rubber or some comparable compound having desired spring-like and damping characteristics, such as opposing polarity magnets. Coupling component 202 may optionally comprise an impedance transition device 206 as described previously, which directly contacts the target media 208 to impart the conducted acoustic wave. Impedance transition device 206 can have any of various types of shapes. In an exemplary embodiment, the impedance transition device 206 has a flat round shape. Under one arrangement, the impedance transition device 206 of the coupling component 202 corresponds to one or more surfaces of the coupling component 202 and, therefore, is not a separate device.

Whereas the coupling component of FIG. 2 has spring-like and damping characteristics and may include an impedance transition device, the coupling component of the present invention does not and instead comprises a coupling chamber and a push plate assembly that is in contact with a target media. The coupling chamber is substantially sealed at the moment of detonation and the pressure produced in the coupling chamber by a generated overpressure wave is applied to push plate assembly directly or via a piston thereby converting the pressure into a force thereby producing a conducted acoustic wave into the target media.

FIG. 3 depicts a cross-section of an exemplary overpressure wave generator. A detonation tube 100 of an overpressure wave generator 11 is attached to a coupling component 202. The detonation tube 100 is oriented to direct a generated overpressure wave towards a target media 208. The coupling component 202 includes a coupling chamber 302, a cylinder 314, a piston 316, and an push plate assembly comprising an earth plate 318, which can be made of a rigid low mass substance such as titanium, aluminum, or composite materials such as carbon composite or fiber glass or high mass substances such as iron or steel.

The detonation tube 100 can have a first diameter d₁ and the coupling chamber 302 can have a second diameter d₂, where the diameter d₂ can be less than or greater than the first diameter d₁. Alternatively, the coupling chamber could have the same diameter as the detonation tube. The coupling chamber can also have a varying diameter and can have a shape other than a round shape, for example, an oval shape, or rectangular shape, or any other desired shape. The coupling chamber has a volume, v, in which a peak pressure is produced when the overpressure wave is generated, where the volume for a round coupling chamber is a function of its height and diameter. Overall, the diameters d1 and d2 and volume v can be selected to have a desired pressure ratio between the pressure in the detonation tube 100 and the pressure in the coupling chamber 302. For example, the pressure in the detonation tube might be on the order of 500 psi while the pressure in the coupling chamber might be on the order of 130 psi.

The coupling chamber 302 may include an outer flange 304a. The cylinder 314 may include a top outer flange 304b and may include a lower outer flange 304c. A rubber or comparable sealing component 308 can be placed between the outer flange 304a of the coupling chamber 302 and the upper outer flange 304b of the cylinder 314. Bolts 310 can be placed in holes in the two flanges 304a 304b and secured with nuts 312 in order to attach the cylinder 314 to the coupling chamber 302. Alternatively, the coupling chamber 302 and cylinder 314 can be welded together or otherwise be a single component. The area of the top of the piston 316 and the pressure applied to it determine the force converted into a conducted acoustic wave in the target media. The area of the plate 318 that is contact with the target media determines the distribution of the force being applied to the target media. Also shown in FIG. 3 is a vent pipe 320 which could have a nozzle, a muffler, and/or a restrictor.

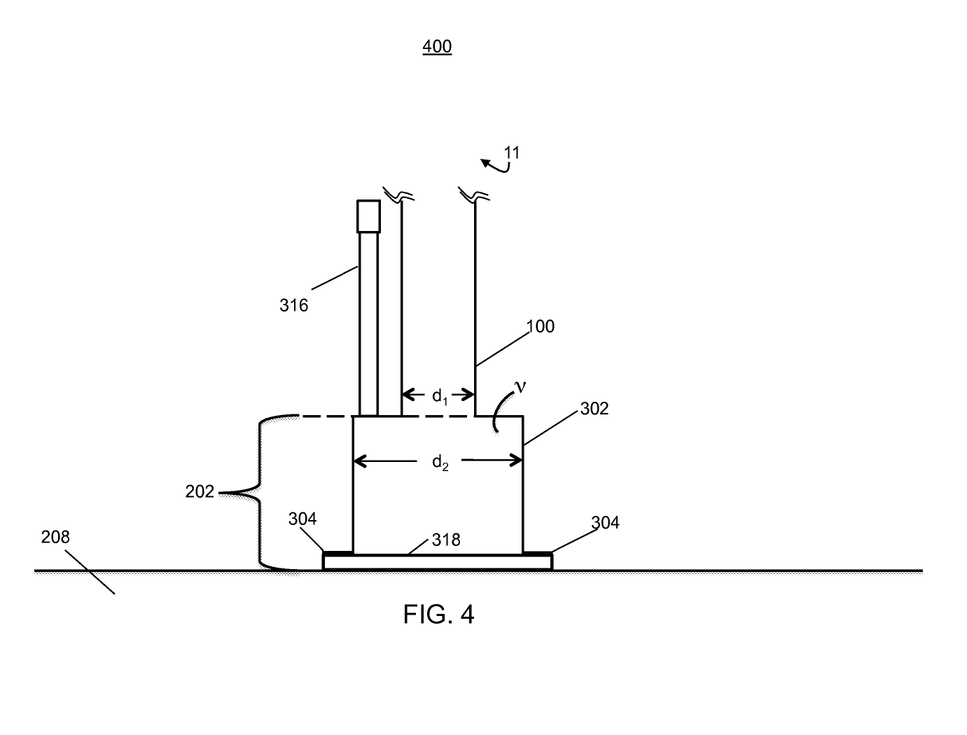

FIG. 4 depicts a cross-section of an exemplary system 400 comprising a overpressure wave generator 11 attached to a coupling component 202 that includes a coupling chamber 302 and a push plate assembly comprising an earth plate 318. The coupling chamber has an outer flange 304 that rests on the plate 318. Such an arrangement requires operation on very hard surfaces like desert earth, roadways, dams, etc.

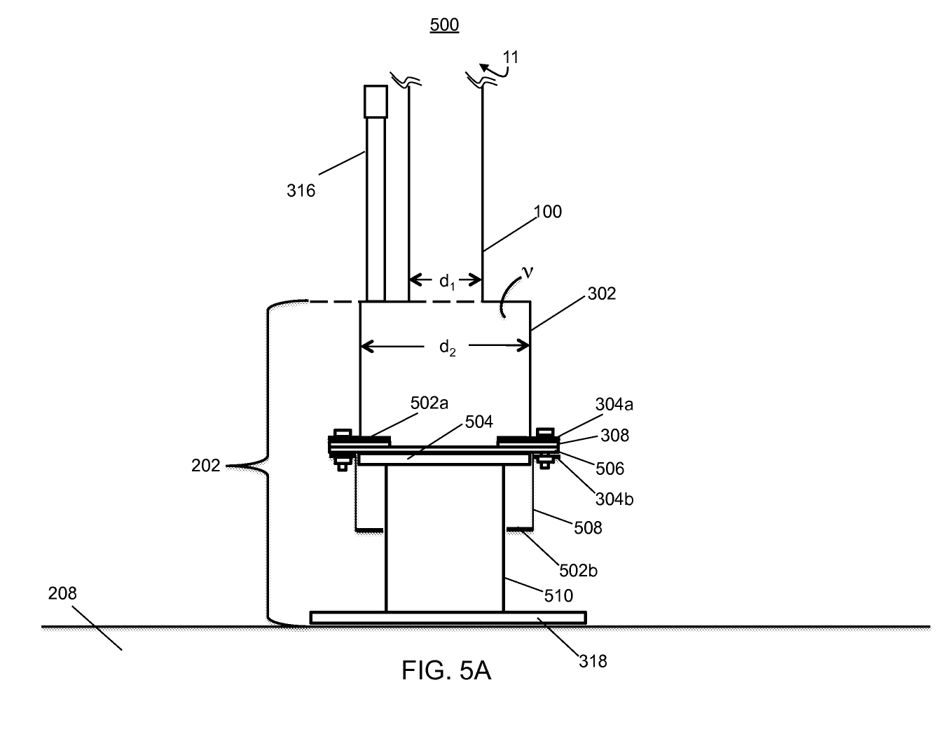

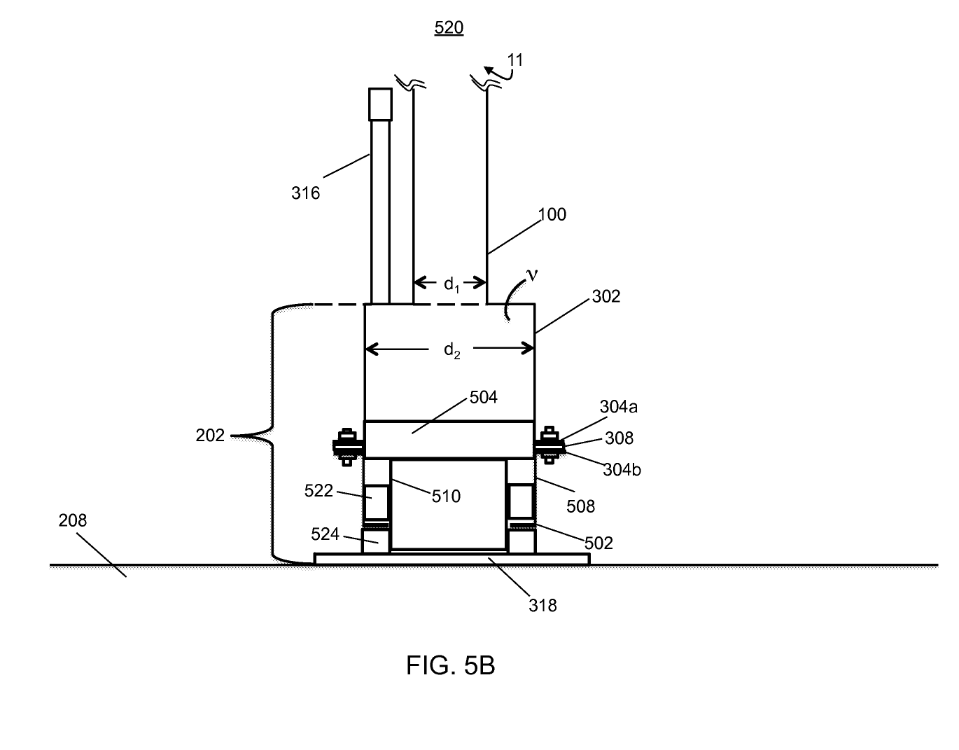

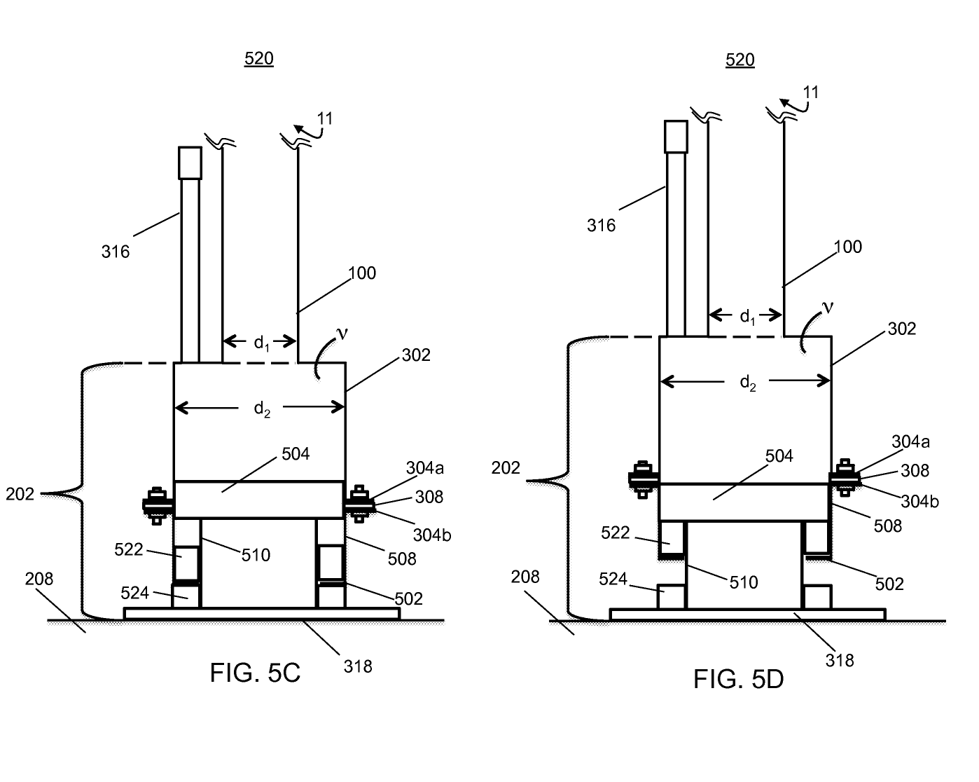

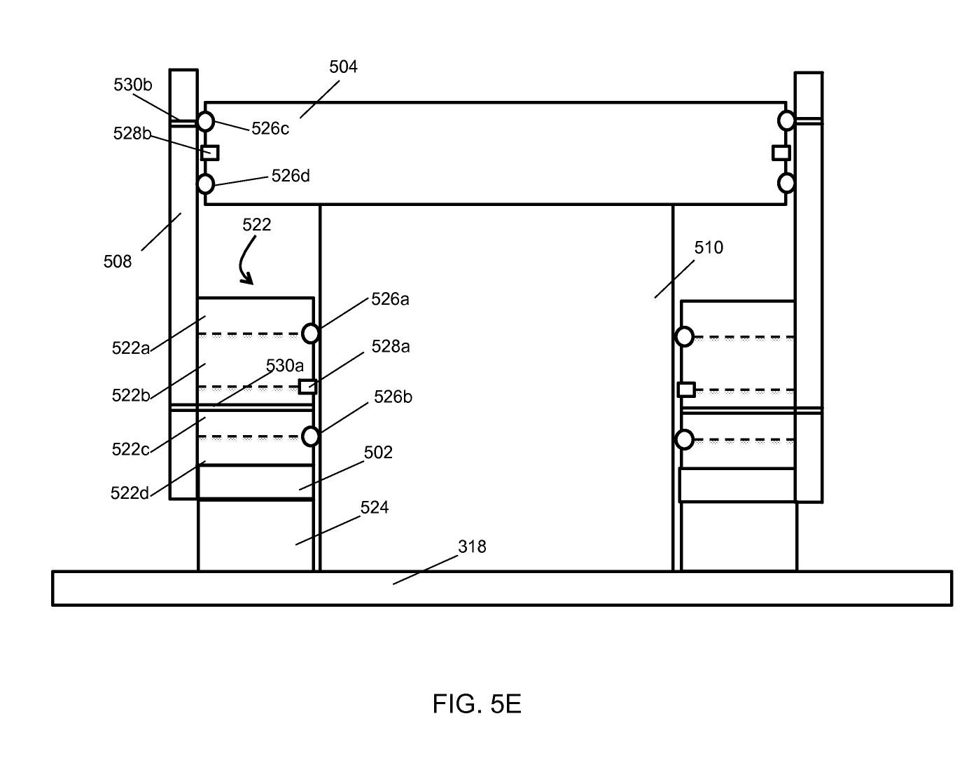

FIG. 5A depicts a cross-section of an exemplary system 500 comprising an overpressure wave generator 11 attached to a coupling component 202 that includes a coupling chamber 302, a flexible membrane 506, and a push plate assembly comprising a top plate 504, a piston rod 510, and an earth plate 318 that is in contact with the target media. The movement of the top plate 504 and piston rod 318 are constrained in movement constraining vessel 508. The coupling chamber 302 includes an inner flange 502a that prevents the top plate 504 from moving upward. A rubber or comparable sealing component 308 is placed between the inner flange 502a (and optionally outer flange 304a) and the flexible membrane 506. The movement constraining vessel has an upper outer flange 304b and an inner flange 502b where the top plate 504 can move between the flexible membrane 506 and the inner flange 502b. The top plate 504 and earth plate 318 may be rigid disks having low mass and strength such as titanium, aluminum, or composite materials such as carbon composite or fiber glass or high mass substances such as iron or steel. The piston rod 510 and movement constraining vessel may each be pipes that are also rigid and low mass and may be titanium, aluminum, or composite materials such as carbon composite or fiber glass or high mass substances such as iron or steel.

FIG. 5B depicts a cross-section of an exemplary system 520 comprising an overpressure wave generator 11 attached to a coupling component 202 that includes a coupling chamber 302, and a push plate assembly comprising a top plate (or piston) 504, a piston rod 510, and an earth plate 318 that is in contact with the target media. The downward movement of the top plate 504 and piston rod 318 are constrained in movement constraining vessel 508. The coupling chamber 302 includes an outer flange 304a. A rubber or comparable sealing component 308 is placed between the outer flange 304a of the coupling chamber 302 and the upper outer flange 304b of the movement constraining vessel 508. The movement constraining vessel has an upper outer flange 304b, a lower inner flange 502, and includes a stabilizing component 522, where the top plate 504 can move downward until it strikes the stabilizing component 522. The stabilizing component is shown being slightly above the lower inner flange 502 (for clarity's sake) but can instead be abutted against the lower inner flange 502. The stabilizing component can be any type of mechanism that constrains movement of the piston rod 510 to only movement that is parallel to the sides of the coupling chamber and movement constraining vessel 508.

A stop component 524, for example a doughnut-shaped rubber stop component, is depicted between the earth plate 318 and the lower inner flange 502 of the movement constraining vessel. Its purpose is to prevent the metal lower inner flange 502 from striking the metal earth plate 318 and thereby prevent the sound of metal striking metal from being produced. Although a rubber stop component 524 is described herein, any other desired material could be used instead of rubber. For clarity's sake, the rubber stop component 524 is depicted being slightly below the lower inner flange 502. However, in normal operation, the lower inner flange 502 could rest upon the rubber stop component 524 prior to detonation such as depicted in FIG. 5C. The thicknesses of the rubber stop 318 and stabilizing component 522 can be selected to limit the movement of the piston rod 510 during a detonation to a desired distance (e.g., three inches). This limiting of movement can be visualized by comparing FIGS. 5C and 5D, which depict the location of the piston rod 510 prior to detonation and immediately after detonation, respectively. As with exemplary system 500, the top plate 504 and earth plate 318 of system 520 may be rigid disks having low mass and strength such as titanium, aluminum, or composite materials such as carbon composite or fiber glass. The piston rod 510 and movement constraining vessel 508 may each be pipes that are also rigid and low mass and may be titanium, aluminum, or composite materials such as carbon composite or fiber glass or high mass substances such as iron or steel.

FIG. 5E depicts a cross section of an exemplary stabilizing component 522. Referring to FIG. 5E stabilizing component 522 comprises four discs 522a-522d, two O-rings 526a 526b, a grease spreading component 528a, and at least one grease port 530a. The stabilizing component 522 could be a circular ring or multiple rings attached together. In

FIG. 5E, stabilizing component 522 comprises four circular rings 522a-522d that are attached by bolts (not shown), which can be loosened to allow the piston rod 510 to be placed into the movement constraining vessel 508, after which the bolts can be tightened causing the O-rings 526a 526b to press against the piston rod 510. During operation, a grease pump (not shown) can periodically provide grease to the at least one grease port 530a, where the grease is spread by the grease spreading component 528a during operation of the device. FIG. 5E also depicts O-rings 526c 526d on the outside of the top plate (or piston) 504, where during operation, grease is periodically provided to at least one grease port 530b and the grease is spread by a grease spreading component 528b. One skilled in the art will recognize that all sorts of stabilizing approaches can be employed to include having O-rings integrated into the piston rod, use of a bushing, use of a rubber doughnut-shape ring similar to the stop component, and the like. Alternatively, the stabilizing component 522 could be permanently packed with grease.

### Channelization of Direct Detonation Overpressure Wave Generators

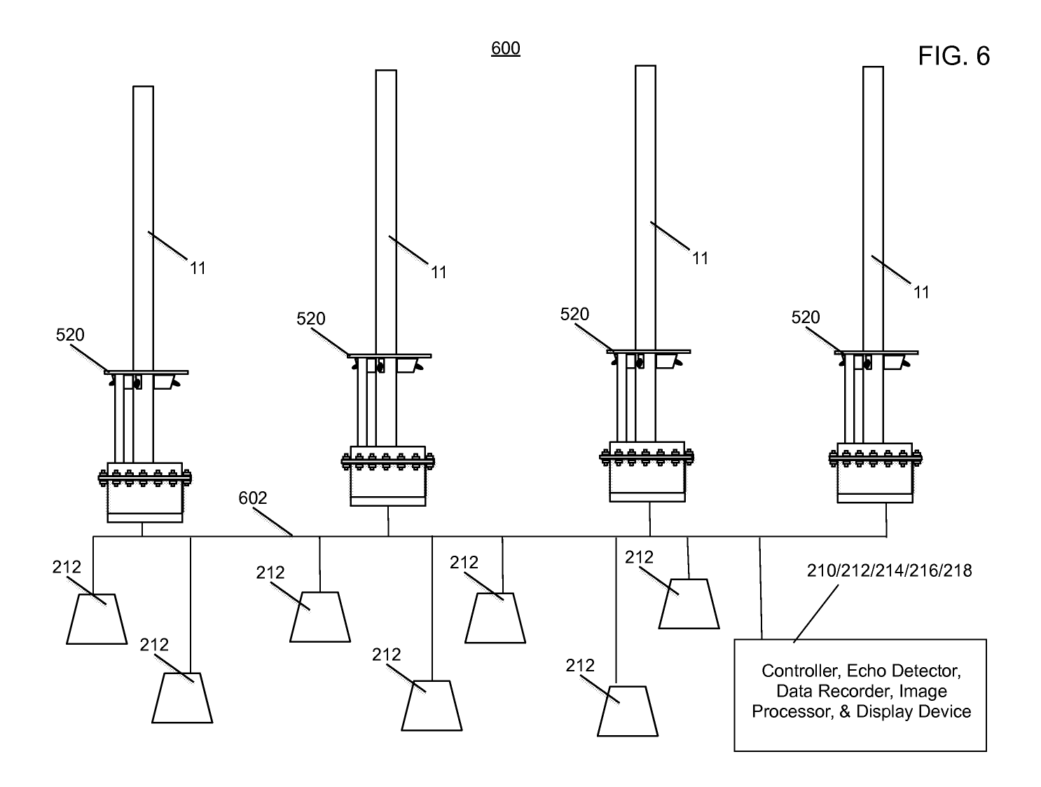

In accordance with one aspect of the present invention depicted in FIG. 6, the responses to seismic impulses produced by a simultaneous seismic impulse acquisition system 600 comprising an array of seismic exploration systems 520 (or seismic sources) comprising direct detonation overpressure wave generators 11 are monitored by an array of echo detectors (e.g. geophones) 212, where the seismic sources are geographically and temporally scattered. The seismic sources and geophones are connected via a network 602 to a control system (or controller) 210, where any combination of wired and/or wireless connectivity can be used. The geophones are also connected to a data recorder 216. The location of each seismic source 200 and each geophone 212 at a given time is known relative to an established coordinate system, for example, a global positioning system (GPS) coordinate system, where a given location of a seismic source or a geophone can be fixed or vary depending on whether the seismic source or geophone is fixed or mobile. Each seismic source 200 imparts seismic pulses into a target media in a coded sequence, for example a time coded sequence, where each seismic source uses a different coded sequence (or code). The various coded sequences of seismic pulses can then be used to process the data received by the data recorder 216 from the array of geophones 212, where the code sequence used by a given seismic source 200 corresponds to its channel. As such, multiple seismic sources 200 can be firing simultaneously using their assigned code sequences and correlation methods can be used to separate the collected information resulting from the firing of a given seismic source 200. The use of coded firing sequences to provide channelization to concurrently firing seismic sources is described in U.S. Pat. No. 4,969,129, issued Nov. 6, 1990, which is incorporated by reference herein in its entirety.

The codes used by the seismic sources of a seismic source array can be selected to have desirable correlation properties. Under one arrangement a given code can be selected to have desirable autocorrelation properties. Under another arrangement families of codes can be selected to have desirable cross correlation properties, where a given code in a code family may be orthogonal (i.e., have zero cross-correlation), or may be substantially orthogonal, to other codes in the code family, such as the Galois sequences disclosed in U.S. Pat. No. 4,969,129. There are various other well known ‘designed’ code families having desirable cross-correlation properties such as Hadamard codes, Gold codes, Walsh codes, Kasami sequences, Chu sequences, hyperbolic congruential codes, quadratic congruential codes, linear congruential codes, chaotic codes, Golomb Ruler codes, and the like. Pseudo-random codes may also be used, which can be produced, for example, using a liner feedback shift-register.

One or more characteristics of seismic impulses can be coded. As described above, the timing of seismic impulses can be coded. Other seismic impulse characteristics that can be coded in addition to or alternatively to timing include seismic impulse amplitude, seismic impulse frequency, and seismic impulse width. Additionally, chirped seismic impulses and chirp processing methods can be employed.

Generally, correlation methods involve multiplying a received signal (or measured data) by a template signal (or a data pattern) to produce an output signal, where the template signal (or data pattern) corresponds to the code of a particular transmitter (or seismic source). Ideally, the time of the firing of a given coded sequence of seismic impulses by a given seismic source is known (e.g., recorded) in which case correlation processing of received (or measured) data is substantially simplified. However, if the time of the firing of a given coded sequence of seismic pulses by a given seismic source is not known than well-known sliding correlation methods can be used to determine (or acquire) the time of firing of a given coded sequence of seismic pulses.

It is preferred that the simultaneous seismic impulse acquisition system be time coherent whereby each seismic source and each geophone is in wired or wireless communication with a common time reference. The time reference may be provided by a time server which may be connected to a radio clock, an atomic clock, a GPS master clock, etc. Example time servers include a National Institute of Standards and Technology time server, a Network Time Protocol server, a Simple Network Time Protocol server, and a GPS Network Time Server.

Given a common time reference, a given seismic source can convey or otherwise report the time that it fires to a control system or it can fire at a required firing time provided by a control system. Under one arrangement, a seismic source will convey to a control system that is ready to fire and it will receive a fire command from the control system. The seismic source will fill its chamber and fire when the appropriate pressure is reached. After firing the seismic source will report the time at which it fired, which will correspond to a measurement of a pressure sensor. Under such an arrangement there will be a delay between the fire command and firing of the seismic source due to the time required to achieve firing conditions. Under an alternative arrangement, a control system will provide an arm command to the seismic source that will initiate the filling of the chamber. When the appropriate pressure is reached the seismic system will send a ready to fire signal to the control system. The control system will initiate the fire command and upon receiving the fire command the seismic system will fire. This approach requires the seismic system to maintain readiness to fire but should provide a far less delay between the command to fire and the actual firing of the seismic source. Ideally, the difference in time between the fire command and the firing will be substantially zero time.

In accordance with yet another aspect of the invention, coded sequences of seismic impulses are repeated over time enabling coherent integration methods to be employed so as to increase signal-to-noise ratios.

One skilled in the art will recognize that the simultaneous seismic impulse acquisition system described herein is analogous to a time coherent impulse radar system. As such, various signal processing methods such as those used in synthetic aperture radar are applicable for processing geophone data. Moreover, coding methods employed with impulse systems are generally applicable for producing coded seismic impulses.

Based on the teachings herein, one skilled in the art will recognize that coding techniques applicable to radio frequency (RF) impulses, or impulse signals, are generally applicable to seismic impulses. In accordance with the invention, a coded sequence of seismic impulse each having a temporal location and impulse amplitude (or strength) will have correlation or other characteristics like those of a similarly coded plurality of RF signals each having a time location and signal strength. As such, one skilled in the art will recognize that many coding techniques developed for time domain signals are generally applicable to designing coded seismic impulses in accordance with the present invention. Examples of such time domain coding techniques that are generally applicable to seismic impulses are provided below.

U.S. Pat. No. 6,636,566, issued Oct. 21, 2003 to Roberts et al. titled “Method and apparatus for specifying pulse characteristics using a code that satisfies predefined criteria”, which is incorporated by reference herein in its entirety, can be translated to a coding method and system for specifying seismic impulse characteristics using a code that specifies temporal and/or non-temporal seismic impulse characteristics according to temporal and/or non-temporal characteristic value layouts having one or more allowable and non-allowable regions. The method generates codes having predefined properties. The method specifies a seismic impulse sequence by mapping codes to the characteristic value layouts, where the codes satisfy predefined criteria. In addition, the predefined criteria can limit the number of seismic impulse characteristic values within a non-allowable region. The predefined criteria can be based on relative seismic impulse characteristic values. The predefined criteria can also pertain to frequency and to correlation properties. The predefined criteria may pertain to code length and to the number of members of a code family.

U.S. Pat. No. 6,636,567, issued Oct. 21, 2003 to Roberts et al. titled “Method of specifying non-allowable pulse characteristics”, which is incorporated by reference herein in its entirety, can be translated to describe coding methods for defining seismic impulse sequences where a code specifies characteristics of seismic impulses. The translated methods define non-allowable regions within seismic impulse characteristic value range layouts enabling non-allowable regions to be considered when generating a code. Various approaches are used to define non-allowable regions based either on the seismic impulse characteristic value range layout or on characteristic values of one or more other seismic impulses. Various permutations accommodate differences between temporal and non-temporal seismic impulse characteristics. Approaches address characteristic value layouts specifying fixed values and characteristic value layouts specifying non-fixed values. When generating codes to describe seismic impulse, defined non-allowable regions within seismic impulse characteristic value layouts are considered so that code element values do not map to non-allowable seismic impulse characteristic values.

U.S. Pat. No. 6,778,603, issued Aug. 17, 2004 to Fullerton et al. titled “Method and apparatus for generating a pulse train with specifiable spectral response characteristics”, which is incorporated by reference herein in its entirety, can be translated to describe a coding method and apparatus for generating seismic impulses with specifiable spectral response characteristics. The initial spatial and non-spatial characteristics of seismic impulses are established using a designed code or a pseudorandom code and the spatial frequency properties of the seismic impulses are determined. At least one characteristic of at least seismic impulse of a sequence of seismic impulses are modified or at least one seismic impulse is added to or deleted from a sequence of seismic impulses and the spatial frequency characteristics of the modified sequence of seismic impulses are determined. Whether or not the modification to the sequence of seismic impulses improved the spectral response characteristics relative to acceptance criteria is determined. The sequence of seismic impulses having the most desirable spectral response characteristics is selected. The optimization process can also iterate and may employ a variety of search algorithms.

U.S. Pat. No. 6,788,730, issued Sep. 7, 2004 to Richards et al. titled “Method and apparatus for applying codes having pre-defined properties”, which is incorporated by reference herein in its entirety, can be translated to describe a coding method and apparatus for defining properties of seismic impulses in the time domain. The translated method for specifying sequence of seismic impulse characteristics applies codes having pre-defined characteristics to a layout. The layout can be sequentially subdivided into at least first and second components that have the same or different sizes. The method applies a first code having first pre-defined properties to the first component and a second code having second pre-defined properties to the second component. The pre-defined properties may relate to the auto-correlation property, the cross-correlation property, and spectral response properties, as examples. The codes can be used to specify subcomponents within a frame, and characteristic values (range-based, or discrete) within the subcomponents.

U.S. Pat. No. 6,959,032, issued Oct. 25, 2005 to Richards et al. titled “Method and apparatus for positioning pulses in time”, which is incorporated by reference herein in its entirety, can be translated to describe a coding method and apparatus for defining positioning seismic impulses in the time domain. The translated method specifies positioning sequence of seismic impulses in the time domain according to a time layout about a time reference where a seismic impulse can be placed at any location within the time layout. The method generates codes having predefined properties, and a sequence of seismic impulses based on the codes and the time layout. The time reference may be fixed or non-fixed and can be a position of a preceding or a succeeding seismic impulse. In addition, the predefined properties can be autocorrelation, cross-correlation, or spectral response properties.

U.S. Pat. No. 7,145,954, issued Dec. 5, 2006 to Pendergrass et al. titled “Method and apparatus for mapping pulses to a non-fixed layout”, which is incorporated by reference herein in its entirety, can be translated to describe a coding method for mapping seismic impulses to a non-fixed the time layout. The translated method specifies temporal and/or non-temporal seismic impulse characteristics, where seismic impulse characteristic values are relative to one or more non-fixed reference characteristic values within at least one delta value range or discrete delta value layout. The method allocates allowable and non-allowable regions relative to the one or more non-fixed references. The method applies a delta code relative to the allowable and non-allowable regions. The allowable and non-allowable regions are relative to one or more definable characteristic values within a characteristic value layout. The one or more definable characteristic values are relative to one or more characteristic value references. In addition, the one or more characteristic value references can be a characteristic value of a given seismic impulse such as a preceding seismic impulse or a succeeding seismic impulse.

One skilled in the art will recognize based on the teachings herein that methods used to determine acquisition of a time domain signal by a time coherent receiver (i.e., a receiver that mixes a template signal with a received signal in a correlator) are generally applicable for determining timing of a time coded sequence of seismic impulses. As such, methods and systems for searching the time domain for acquiring a signal such as those found in U.S. Pat. No. 6,925,109, issued Aug. 2, 2006 to Richards et al. titled “Method and apparatus for fast acquisition of ultra-wideband signals”, which is incorporated by reference herein in its entirety, can be translated into methods and systems for acquiring a time sequence of seismic impulses.

### Multiplexing of Direct Detonation Overpressure Wave Generators

In accordance with another aspect of the present invention, one or more multiplexing methods can be employed in a simultaneous seismic impulse acquisition system. For example, timing windows can be defined and coordinated among the various seismic sources where a given seismic source has a schedule of timing windows within which the seismic source is to fire in order to produce one or more coded sequences of seismic impulses. Under one approach, a seismic source is required to fire at a specific time corresponding to a specific window of time. Under another approach, a seismic source is required to fire within a window of time but can otherwise determine when it fires within a given window of time. With a time window approach, which is analogous to a Time Division Multiple Access (TDMA) channel access method, seismic sources having codes with cross-correlation characteristics that are undesirable can be assigned different windows where they will never interfere with each other. As such, codes within families of codes can be distributed geographically to distributed seismic sources and managed temporally based on code correlation characteristics so as to limit interference.

One skilled in the art will recognize based on the teachings herein that well known methods used to multiplex RF signals can be applied to multiplex seismic impulses of multiple seismic sources. For example, a Code Division Multiple Access (CDMA) method or a Frequency Division Multiple Access (FDMA) method could be employed.

### Low Noise Firing of a Direct Detonation Overpressure Wave Generator

In accordance with a further aspect of the present invention, the firing of a coded sequence of impulses by a seismic source is controlled based on one or more noise measurements, where it is desirable to impart the seismic impulses into a target media during a period of low noise. As such, a given seismic source is either authorized to fire by a control system monitoring the noise in the target media due to other seismic sources firing, or the seismic source has direct access to one or more geophones uses to measure the noise present in the target media so a local decision to fire or not can be made. In either case, a noise threshold can be established to which noise measurement data can be compared to determine whether a given seismic source should fire or not. A noise threshold could, for example, correspond to a root mean square of an average noise measurement corresponding to one or more geophones.

Under one arrangement, a seismic source has a schedule of time windows in which it is authorized to fire. For a given window within the schedule of time windows, the seismic source may or may not fire due to measured noise and an established noise threshold, where whenever a seismic sources does fire to impart is coded sequence of impulses, it reports (or otherwise records) the timing of its firing to be used for processing.

Various statistical algorithms can also be used which determine (and therefore predict) noise patterns based on firing activity over time, which is analogous to monitoring network activity on a computer network over time, where authorization to fire or a decision to fire is based on a determined noise pattern.

While particular embodiments of the invention have been described, it will be understood, however, that the invention is not limited thereto, since modifications may be made by those skilled in the art, particularly in light of the foregoing teachings.

1. A seismic impulse acquisition system, comprising:
an array of seismic sources comprising direct detonation overpressure wave generators, each of the seismic sources of said array of seismic sources being geographically scattered, wherein each seismic source of said array of seismic sources imparts seismic impulses into a target media in accordance with a respective code sequence of a plurality of code sequences;
an array of echo detectors configured to detect said seismic impulses imparted by each seismic source of said array of seismic sources;
a data recorder, said array of echo detectors being connected to said data recorder;
a control system;
a network, said network connecting said array of seismic sources and said array of echo detectors to said control system; wherein the location of each seismic source of said array of seismic sources and each echo detector of said array of echo detector at a given time is known relative to an established coordinate system; wherein the various coded sequences of seismic pulses are used to process the data received by the data recorder from the array of echo detectors; wherein multiple seismic sources of said plurality of seismic source can be firing simultaneously.

2. The seismic impulse acquisition system of claim 1, wherein each code sequence of said plurality of code sequences corresponds to a channel.

3. The seismic impulse acquisition system of claim 1, where the respective code sequences used by a given seismic source and correlation methods can be used to determine information resulting from the firing of a given seismic source.

4. The seismic impulse acquisition system of claim 1, wherein said network comprises at least one of wired connectivity or wireless connectivity.

5. The seismic impulse acquisition system of claim 1, wherein said established coordinate system is a global positioning system coordinate system.

6. The seismic impulse acquisition system of claim 1, wherein a location of a given seismic source of said array of seismic sources or a location of a given echo detector of said array of echo detectors can be fixed or vary depending on whether the given seismic source or the given echo detector is fixed or mobile.

7. The seismic impulse acquisition system of claim 1, wherein a code sequence of said plurality of code sequences can be substantially orthogonal to any other code sequence of said plurality of code sequences.

8. The seismic impulse acquisition system of claim 1, wherein a code sequence may correspond to a Galois sequence.

9. The seismic impulse acquisition system of claim 1, wherein a code sequence may correspond to one of a Hadamard code, Gold code, Walsh code, Kasami sequence, Chu sequence, hyperbolic congruential code, quadratic congruential code, linear congruential code, chaotic code, Golomb Ruler code, or pseudo-random code.

10. The seismic impulse acquisition system of claim 1, wherein a code sequence may be a time coded sequence.

11. The seismic impulse acquisition system of claim 1, wherein a code sequence defines at least one of seismic impulse amplitude, seismic impulse frequency, or seismic impulse width.

12. The seismic impulse acquisition system of claim 1, wherein chirped seismic impulses and chirp processing methods are employed.

13. The seismic impulse acquisition system of claim 1, wherein each seismic source and each echo detector is in wired or wireless communication with a common time reference.

14. The seismic impulse acquisition system of claim 13, wherein the common time reference may be provided by a time server which may be connected to one of a radio clock, an atomic clock, or a GPS master clock.

15. The seismic impulse acquisition system of claim 1, wherein coded sequences of seismic impulses are repeated over time enabling coherent integration methods to be employed so as to increase signal-to-noise ratios.

16. The seismic impulse acquisition system of claim 1, wherein seismic impulses are produced in accordance with one of Division Multiple Access (TDMA) channel access method, a Code Division Multiple Access (CDMA) method, or a Frequency Division Multiple Access (FDMA) method.

17. The seismic impulse acquisition system of claim 1, wherein the firing of a coded sequence of impulses by a seismic source is controlled based on one or more noise measurements.

18. The seismic impulse acquisition system of claim 17, wherein a given seismic source has a schedule of time windows in which it is authorized to fire.

19. The seismic impulse acquisition system of claim 18, wherein for a given window within the schedule of time windows, the seismic source may or may not fire due to measured noise and an established noise threshold.

20. The seismic impulse acquisition system of claim 19, wherein whenever a seismic source fires it reports or records the timing of its firing to be used for processing.
